(19) United States
(12) Patent Application Publication
(10) Pub. No.: US 2008/0316289 A1
(43) Pub. Date: Dec. 25, 2008

(54) Composition suitable for use in ink jet printing

(75) Inventor: Janette Cordwell, Blackley (GB)

Correspondence Address: MORGAN LEWIS & BOCKIUS LLP, 1111 PENNSYLVANIA AVENUE NW, WASHINGTON, DC, 20004, US

(73) Assignee: Fujifilm Imaging Colorants Limited

(21) Appl. No.: 11/882,220

(22) Filed: Jul. 31, 2007

(30) Foreign Application Priority Data
Jun. 21, 2007 (GB) 0711964.7

(51) Int. Cl. C09D 11/02; B41J 27/00; C09B 67/00

(52) U.S. Cl. 347/100; 106/31.47; 8/527

(57) ABSTRACT

A composition comprising a black dye of Formula (1) or a salt thereof and of a dye of Formula (2) or a salt thereof:

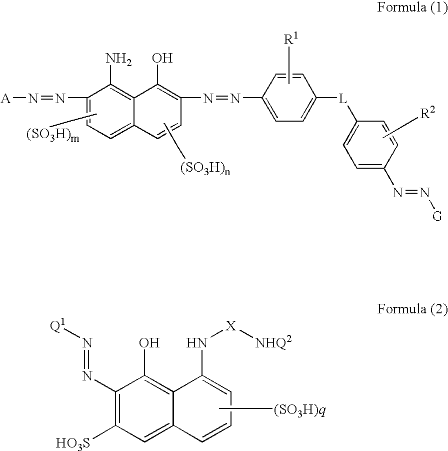

wherein A, G, m, n, R¹, R², Q¹, Q², X and q are as defined in the claims.

This invention relates to a composition comprising two or more dyes, to inks containing such compositions and to their uses in ink jet printing.

Ink jet printing is a non-impact printing technique which involves ejecting, thermally or by action of an oscillating piezo crystal, droplets of ink continuously or on demand from a fine nozzle directly onto a substrate but without contacting the substrate. The inks used in an ink jet printer are required to meet a number of criteria. In the black shade area it is desirable to obtain prints with neutral black shades with good fastness properties but this has been difficult to achieve. In addition the inks desirably provide sharp, non-feathered images which have good water fastness, gas fastness, light fastness and optical density. The inks are required to dry quickly when applied to a substrate, however, they must not dry or crust over in the ink jet head as this can result in clogging of the ink jet nozzle. The inks are also required to be storage stable for long periods of time without deterioration in the properties of the ink.

U.S. Pat. No. 4,479,906 describes black colorants for dyeing hydroxy-containing nitrogenous materials, particularly leather.

PCT patent application WO03/068867 describes the shading of certain dyes related in structure to those in U.S. Pat. No. 4,479,906 with certain magenta dyes. However the proposed magenta dyes are quite complicated in terms of their chemical formulae and as a result are relatively expensive in terms of the number of manufacturing steps and raw materials required. Furthermore, the end performance properties of the resultant dye mixtures leave something to be desired, for example the black and magenta dye components can separate out on certain media to give unsightly prints.

We have now found that mixtures of certain dyes are valuable as colorants for ink jet printing inks, providing neutral black shades with good fastness properties and low tendency for the dyes to separate out when printed. The prints also demonstrate good ozone and light fastness properties.

According to a first aspect of the present invention there is provided a composition comprising a dye of Formula (1) or salt thereof and a dye of Formula (2) or salt thereof:

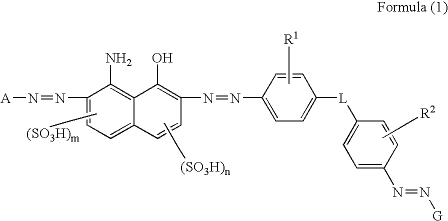

wherein:
A and G are optionally substituted aryl groups;
m is 0 or 1;
n is 0 or 1;
(m+n) is 1 or 2;
R¹ and R² are each independently H, optionally substituted alkyl, optionally substituted alkoxy, sulpho or carboxy; and
L is NH, SO₂NH or CONH; and

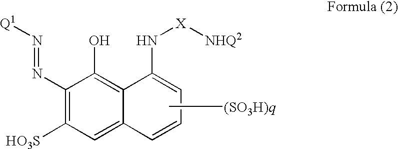

wherein:
Q¹ and Q² are each independently optionally substituted aryl groups;
X is an optionally substituted triazine or pyrimidine group; and
q is 0 or 1.

The optional substituents which may be present on A are preferably selected from NO₂, carboxy and sulpho, most preferably NO₂.

The optional substituents which may be present on G are preferably of the formula —NR^{a}R^{b} wherein one of R^{a} and R^{b} is H and the other is H or C₁₋₆-alkyl. More preferably both R^{a} and R^{b} are H.

R¹ and R² are preferably each independently halo, H, carboxy or sulpho. Most preferably R¹ and R² are both H.

L is preferably SO₂NH.

Preferably m and n each have a value of 1.

A, G, Q¹ and Q² are preferably unsubstituted or carry 1 or 2 substituents.

Q¹ and Q² are preferably each independently optionally substituted naphthyl or phenyl, more preferably naphthyl or phenyl carrying at least one substituent and especially one or two substituents. The substituent(s) are preferably selected from carboxy alkyl, especially C₁₋₄-alkyl; alkoxy, especially C₁₋₄-alkoxy; sulpho; —PO₃H₂; —COSH; —OH; carboxy; halogen, especially Cl or Br; and optionally substituted C₁₋₄-alkyl. However, it is preferred that each of Q¹ and Q² carries one or two substituents selected from carboxy and sulpho. More preferably Q¹ carries one carboxy group and one sulpho group. Examples of groups which may be represented by Q¹ and Q² include 3-sulphophenyl, 4-sulphophenyl, 2-carboxy-4-sulphophenyl, 1-sulphonaphth-2-yl, dicarboxyphenyl, e.g. 2,4-dicarboxyphenyl, 2,3-dicarboxyphenyl, 3,4-dicarboxyphenyl and 3,5-dicarboxyphenyl.

Preferably q is 1. When q is 1 the relevant sulpho group is preferably at the 6-position of the naphthalene ring relative to the hydroxy group shown in Formula (2).

The preferred triazine and pyrimidine groups represented by X are of Formula (3) or (4):

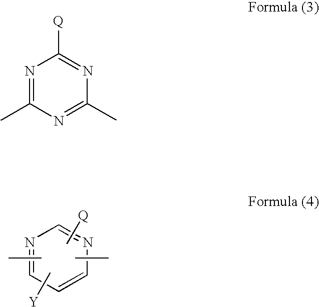

wherein:
each Q independently is H, halogen, alkyl, NR³R⁴, SR⁵ or OR⁵;
each Y independently is NR³R⁴, SR⁶ or OR⁶; and
R³, R⁴, R⁵ and R⁶ are each independently H or optionally substituted alkyl, alkenyl, cycloalkyl, aryl, aralkyl, or aralkyl, or R³ and R⁴ together with the nitrogen atom to which they are attached form a 5- or 6- membered ring.

When X is of Formula (4) it is preferred that Q is attached to the carbon atom between the two ring nitrogen atoms and that Y is para to Q. X is preferably of Formula (3).

Q is preferably Cl, OR⁵, SR⁵ or NR³R⁴, especially Cl; OH; SH; alkoxy, such as methoxy or ethoxy; hydroxy-C₂₋₄-alkylamino, such as mono or di-(2-hydroxyethyl)amino; morpholinyl; piperidinyl; piperazinyl; 4-(hydroxy-C₂₋₄-alkyl)-piperazin-1-yl, such as 4-hydroxyethylpiperazin-1-yl; 4-(C₁₋₄-alkyl)piperazin-1-yl, such as 4-methylpiperazin-1-yl; C₁₋₆-alkylamino, such as dimethylamino, n-butylamino or n-hexylamino; carboxy-C-₁₋₄-alkylamino, such as 2-carboxymethylamino; arylamino, such as phenylamino, mono-3- or di-3,5-carboxyanilino; or aralkylamino, such as benzylamino, mono-3- or di-3,5-carboxyphenylmethylamino. Where Q is alkyl or alkoxy these preferably contain from 1 to 4 carbon atoms. Where at least one Q is halogen, the compound of Formula (2) may be reactive with cellulose under appropriate temperature and pH conditions. However, this does not appear to contribute to the wet-fastness of the compound when applied to a paper substrate under the normal conditions used in ink jet printing and compounds in which Q is not a cellulose reactive group have been found to give equally wet-fast prints on paper to those in which Q is a cellulose reactive group.

Each of R³, R⁴, R⁵ and R⁶ independently is preferably selected from H; C₁₋₁₀-alkyl, especially C₁₋₄-alkyl; substituted C₁₋₁₀-alkyl, especially substituted C₁₋₄-alkyl; phenyl; substituted phenyl; (CH₂)₁₋₄-phenyl; and substituted (CH₂)₁₋₄-phenyl, especially benzyl and substituted benzyl.

When any one of R¹, R², R³, R⁴, R⁵ or R⁶ is substituted, the substituent is preferably selected from —OH, —CH₃, —OCH₃, sulpho and carboxy. When R³ and R⁴ together with the nitrogen radical to which they are attached form a 5- or 6-membered ring, this is preferably morpholine, piperidine or piperazine especially the latter in which the free ring N-atom may be, and preferably is, substituted by a C₁₋₄-alkyl or hydroxy-C₂₋₄-alkyl group.

The present invention relates not only to mixtures of compounds of Formula (1) and Formula (2) in the free acid form, but also to a salt or salts thereof, especially an alkali metal, ammonium or substituted ammonium salt. Alkali metal salts are preferably sodium, lithium or potassium.

An especially preferred dye of the Formula (1) is of the Formula (1a) or a salt thereof:

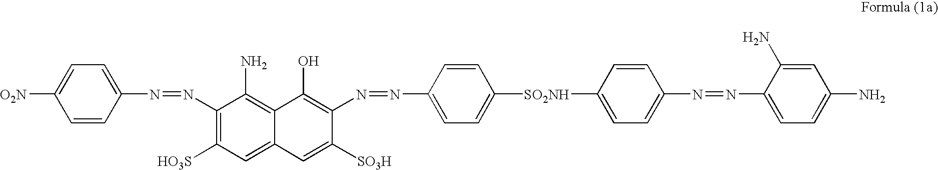

The above dye is available commercially from BASF under the trade name Luganil™ Black NT.

The composition may contain a single dye of Formula (2) or a mixture of two or more different dyes of Formula (2).

The composition preferably comprises from 3 to 10 parts in total of dye(s) of Formula (1) per 1 part in total of dye(s) of Formula (2), preferably 4 to 7 parts in total of dye(s) of Formula (1) per 1 part in total of dye(s) of Formula (2), more preferably 5 to 6 parts in total of dye(s) of Formula (1) per 1 part in total of dye(s) of Formula (2), especially 5 parts in total of dye(s) of Formula (1) per 1 part in total of dye(s) of Formula (2); wherein the parts are by weight. In a preferred embodiment the composition comprises one dye of Formula (1) and one dye of Formula (2).

In preferred compositions of the invention, the dye of Formula (2) is of the Formula (2a) or (2b) or a salt thereof:

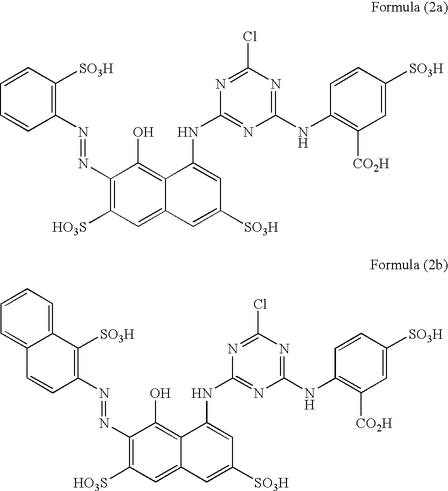

Dyes of Formula (1) can be prepared according to standard synthetic methods commonly used in the dyestuff art, involving sequential diazotisation of amines (typically using NaNO₂ in dilute mineral acid at <5° C.) and coupling the resultant amines onto the desired coupling components. These commonly used methods are described in detail in U.S. Pat. No. 4,479,906, columns 2, line 42 to column 3, line 63, which are herein incorporated by reference thereto.

Dyes of Formula (2) can be prepared by condensing an amine of formula H₂NQ² with a compound of the Formula (5):

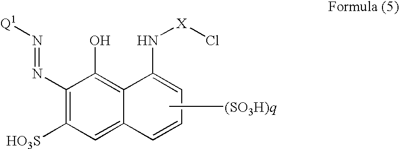

according to standard synthetic methods, wherein Q¹, Q², X and q are as hereinbefore defined.

Dyes of Formula (5) can be prepared by condensing a compound of formula Cl—X—Cl with a compound of the Formula (6), wherein Q¹, X and q are as hereinbefore defined:

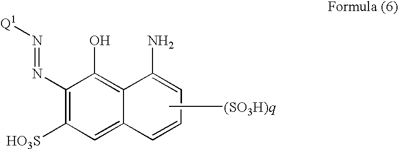

The compounds of Formula (6) may be prepared by diazotising an amine of formula Q¹-NH₂ and, for example using NaNO₂ in dilute hydrochloric acid at 0 to 5° C., and coupling the resultant diazonium salt onto the relevant naphthalene compound.

The dyes of Formula (1) and (2) may be converted into the free acid form or into a salt with a counter ion other than sodium by using well known techniques. For example, the alkali metal salts of the dye of Formula (1) and (2) may be converted into a salt with ammonia or an amine by dissolving the dye in the form of a salt with an alkali metal, acidifying with a mineral acid and adjusting the pH of the solution to pH 9 to 9.5 with ammonia or the amine and removing the alkali metal cations by dialysis. An example of a suitable process for converting the sodium salt of the dye of Formula (1) or (2) to the ammonium salt is analogous to that described in Example 21 of EP0356080A.

The compositions according to the present invention are particularly useful when incorporated into inks for use in ink jet printers because they provide high quality prints with a good optical density, good fastness properties and a particularly desirable neutral black shade. These effects are achieved even on inexpensive plain paper. Furthermore, the compositions can provide prints which do not suffer from the problem of dye separation on the substrate.

The dyes present in the compositions according to the present invention may be in free acid form but are preferably in the form of water-soluble salt. Preferred salts are alkali metal salts, especially lithium, sodium and potassium salts or ammonium and substituted ammonium salts. Especially preferred salts are those formed with ammonia and volatile amines.

The dyes in the compositions according to the present invention may be, and preferably are, purified to remove undesirable impurities before they are incorporated into inks for ink jet printing. Preferably the total concentration of undesirable ions is less than 10 parts per million, more preferably less than 5 parts per million, by weight relative to the weight of ink. Conventional techniques may be employed for purifying the dyes, for example ultrafiltration, reverse osmosis and/or dialysis.

According to a second aspect of the present invention there is provided an ink comprising a composition according to the first aspect of the present invention and a liquid medium.

A preferred ink comprises:
(i) 0.01 to 20 parts of a composition according to the first aspect of the present invention; and
(ii) 99.99 to 80 parts of a liquid medium;
   wherein all parts are by weight and the number of parts (i) +(ii) =100.

The number of parts of component (i) is preferably from 0.1 to 15, more preferably 1 to 10 and especially from 2 to 8.

It is preferred that the components present in the composition according to the first or second aspect of the present invention are dissolved completely in the medium to form a solution. Preferably the compositions have a solubility of 10% or more in the medium because this allows the preparation of concentrates which may be used to prepare more dilute inks and to minimise the chance of precipitation of colorant if evaporation of the liquid medium occurs during storage of the ink.

The liquid medium preferably comprises water, a mixture of water and one or more organic solvent(s), or an organic solvent.

When the liquid medium comprises a mixture of water and one or more organic solvent(s), the weight ratio of water to organic solvent(s) is preferably from 99:1 to 1:99, more preferably from 99:1 to 50:50 and especially from 95:5 to 70:30.

It is preferred that the organic solvent(s) present in the mixture of water and organic solvent(s) are water-soluble organic solvent(s). Preferred water-soluble organic solvent(s) are selected from C₁₋₆-alkanols, for example methanol, ethanol, n-propanol, isopropanol, n-butanol, sec-butanol, tert-butanol, isobutanol and n-pentanol; cyclic alkanols, for example cyclohexanol and cyclopentanol; diols, preferably diols with 2 to 12 carbon atoms, for example pentane-1,5-diol; amides, for example dimethylformamide or dimethylacetamide; ketones or ketone-alcohols, for example acetone, methyl ether ketone, cyclohexanone and diacetone alcohol; ethers, for example tetrahydrofuran or dioxane; oligo- or poly-alkylene-glycols, for example diethylene glycol, triethylene glycol, hexylene glycol, polyethylene glycol and polypropylene glycol; alkyleneglycols or thioglycols containing a C₂₋₆-alkylene group, for example ethylene glycol, propylene glycol, butylene glycol, pentylene glycol hexylene glycol and thiodiglycol; polyols, for example glycerol, pentan-1,5-diol and 1,2,6-hexanetriol; C₁₋₄-alkyl-ethers of polyhydric alcohols, for example 2-methoxyethanol, 2-(2-methoxyethoxy)ethanol, 2-(2-ethoxyethoxy)-ethanol, 2-[2-(2-methoxyethoxy)ethoxy]-ethanol, 2-[2-(2-ethoxyethoxy)-ethoxy]-ethanol, 2-(2-butoxyethoxy)ethanol and ethylene-glycol-monoallylether; cyclic amides, for example 2-pyrrolidone, N-methyl-2-pyrrolidone, N-ethyl-2-pyrrolidone, caprolactam and 1,3-dimethylimidazolidone; cyclic esters, for example caprolactone; sulphoxides, for example dimethyl sulphoxide and sulpholane or mixtures containing two or more, especially from 2 to 8, of the aforementioned water-soluble organic solvents, for example thiodiglycol and a second glycol or diethylene glycol and 2-pyrrolidone.

Especially preferred water-soluble organic solvents are 2-pyrrolidone; N-methyl-pyrrolidone; alkylene- and oligo-alkylene-glycols, for example ethyleneglycol, diethyleneglycol, triethyleneglycol; and lower alkyl ethers of polyhydric alcohols, for example 2-methoxy-2-ethoxy-2-ethoxyethanol; and polyethyleneglycols with a molecular weight of up to 500.

Examples of further suitable ink media comprising a mixture of water and one or more organic solvent(s) are given in U.S. Pat. No. 4,963,189, U.S. Pat. No. 4,703,113, U.S. Pat. No. 4,626,284 and EP 4,251,50A which are incorporated herein by reference thereto.

It is preferred for the inks to be in a high purity form. Ultra-filtration (UF), reverse osmosis (RO) and for ion exchange may be used to render the total concentration of undesirable ions (e.g. halide, nitrite, nitrate, sulphate, peroxide, divalent metal, trivalent metal and silicon) less than 5 or 10 parts per million by weight relative to the weight of ink.

When the liquid medium comprises an organic solvent it preferably has a boiling point of from 0 to 300° C., more preferably of from 50 to 200° C. The organic solvent may be water-immiscible or water-soluble. Preferred water-soluble organic solvents are any of the hereinbefore mentioned water-soluble organic solvents. Preferred water-immiscible solvents include, for example, aliphatic hydrocarbons, esters, such as ethyl acetate, chlorinated hydrocarbons, such as CH₂Cl₂ and ethers, such as diethyl ether.

When the liquid medium comprises a water-immiscible organic solvent a polar solvent such as an alcohol, ester, ether or amide is preferably added to enhance the solubility of the dyes in the medium. It is especially preferred that where the medium comprises an organic solvent, this is a ketones, especially methyl ethyl ketone or an alkanol especially ethanol and/or and n-propanol.

When the liquid medium comprises an organic solvent, it may comprise a single organic solvent or a mixture of two or more organic solvents. It is preferred that the liquid medium comprises a mixture of 2 to 5 different organic solvents because this allows control to be exerted over the characteristics of the ink.

Inks in which the liquid medium is wholly or mainly an organic solvent are used where fast drying times are required and particularly when printing onto hydrophobic and non absorbent substrates such as plastics, metal or glass.

The compositions according to the present invention are particularly useful as colorants for aqueous ink jet inks because they have an attractive neutral black shade, exhibit high solubility in water and aqueous media and have high humidity and ozone fastness on substrates, often surface treated papers, used for the preparation of photorealistic prints. Accordingly, it is preferred that the ink medium is water or, more preferably, a mixture of water and one or more water-soluble organic solvent(s).

The liquid medium may contain other components conventionally used in ink jet printing inks, for example viscosity and surface tension modifiers, corrosion inhibitors, kogation reducing additives, and surfactants which may be ionic or non-ionic.

According to a third aspect of the present invention there is provided a process for printing a substrate with an ink using an ink jet printer, characterised in that the ink is as defined in the second aspect of the present invention.

The ink jet printer preferably applies the ink to the substrate in the form of droplets which are ejected through a small orifice onto the substrate. Preferred ink jet printers are piezoelectric ink jet printers and thermal ink jet printers. In thermal ink jet printers, programmed pulses of heat are applied to the ink in a reservoir having a small orifice by means of a resistor adjacent to the orifice, thereby causing the ink to be ejected through the orifice in the form of small droplets directed towards the substrate during relative movement between the substrate and the orifice.

The substrate used in the ink jet printing process is preferably paper, plastic, textile, metal or glass, more preferably paper, an overhead projector slide or a textile material, and especially paper.

Preferred papers are plain or treated papers which may have an acid, alkaline or neutral character.

According to a fourth aspect of the present invention, there is provided a paper, an overhead projector slide or a textile material printed with an ink composition as hereinbefore defined in the second aspect of the present invention, or by means of the process according to the third aspect of the present invention.

A fifth feature of the present invention provides an ink jet printer cartridge, optionally refillable, comprising a chamber and an ink wherein the ink is present in the chamber and is as defined in the second aspect of the present invention.

The invention is illustrated by the following examples.

### EXAMPLES 1 to 5

### Preparation of Dye Compositions

Dye compositions may be prepared having the following ingredients and amounts shown in Table 1. The amounts quoted refer to the number of parts by weight of each component. Dyes 1 and 2 and 3 are the Na⁺, NH₄⁺ and NH₄⁺ salts respectively of the dyes shown below.

Dye 1 can be prepared by standard synthetic methods such as those described in U.S. Pat. No. 4,479,906, columns 2, line 42 to column 3, line 63, particularly Example 109, and is also available commercially as Luganil™ Black NT from BASF. Dye 2 can be synthesised as outlined above or purchased from Fujifilm Imaging Colorants Limited.

The dyes in the compositions may be purified to remove undesirable impurities by conventional techniques such as ultrafiltration, reverse osmosis and/or dialysis, such that the total concentration of undesirable ions is less than 5 parts per million (p.p.m.) relative to the weight of ink.

TABLE 1

| | Dye 1 | Dye 2 | Dye 3 |
|---|---|---|---|
| Example | (parts by weight) | (parts by weight) | (parts by weight) |
| 1 | 5 | 1 | 0 |
| 2 | 4 | 1 | |
| 3 | 3 | 1 | |
| 4 | 4 | | 1 |
| 5 | 4 | 0.5 | 0.5 |

Dye 1

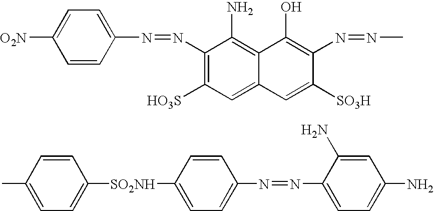

Dye 2

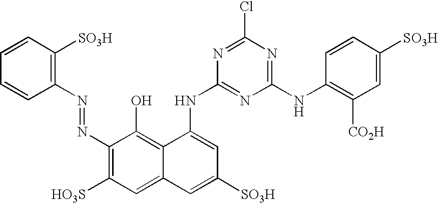

Dye 3

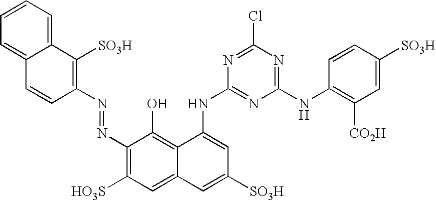

### EXAMPLES 6 to 10

### Preparation of Inks

Inks 6 to 10 may be prepared as follows where all amounts are parts by weight and the dye composition contained in each ink is as described in Table 2 below:

| | | | |
|---|---|---|---|
| (a) | 3 | parts | of a dye composition according to one of the |
| | | | above examples |
| (b) | 74.8 | parts | water; |
| (c) | 7 | parts | diethylene glycol; |
| (d) | 7 | parts | 2-pyrollidone; |
| (e) | 7 | parts | ethylene; |
| (f) | 1 | part | Surfynol ™ 465 (an acetylenic surfactant); and |
| (g) | 0.2 | parts | TRIS buffer. |

(Surfynol is a trade mark of Air Products)

TABLE 2

| Ink Example | Composition |
|---|---|
| Example 6 | from Example 1 |
| Example 7 | from Example 2 |
| Example 8 | from Example 3 |
| Example 9 | from Example 4 |
| Example 10 | from Example 5 |

The inks may be purified using standard ultrafiltration (UF), reverse osmosis (RO) and ion exchange techniques to give very low (<5 p.p.m) concentrations of undesirable ions.

### EXAMPLE 11

### Ink-Jet Printing

The inks described in Examples 6 to 10 may be printed onto a variety of papers using a Hewlett Packard DeskJet 560C™ ink jet printer.

### Further Inks

The inks described in Tables I and II may be prepared wherein the Dye Mixture described in the first column is the composition made in the above example of the same number. Numbers quoted in the second column onwards refer to the number of parts of the relevant ingredient and all parts are by weight. The inks may be applied to paper by thermal or piezo ink-jet printing.

The following abbreviations are used in Table I and II:
PG=propylene glycol
DEG =diethylene glycol
NMP=N-methyl pyrollidone
DMK=dimethylketone
IPA=isopropanol
MEOH=methanol
2P=2-pyrrolidone
MIBK=methylisobutyl ketone
P12=propane-1,2-diol
BDL=butane-2,3-diol
CET=cetyl ammonium bromide
PHO=Na₂HPO₄ and
TBT=tertiary butanol
TDG=thiodiglycol

TABLE I

| | Dye | | | | | | | | | | | |
|---|---|---|---|---|---|---|---|---|---|---|---|---|
| Dye | Mixture | | | | | | | Na | | | | |
| Mixture | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 1 | 3.0 | 90 | | 5 | 5 | | 0.2 | | | | | |
| 1 | 10.0 | 85 | 3 | | 3 | 3 | | | | 5 | 1 | |
| 2 | 2.1 | 91 | | 8 | | | | | | | | 1 |
| 2 | 3.1 | 86 | 5 | | | | | 0.2 | 4 | | | 5 |
| 2 | 1.1 | 81 | | | 9 | | 0.5 | 0.5 | | | 9 | |
| 1 | 2.5 | 60 | 4 | 15 | 3 | 3 | | | 6 | 10 | 5 | 4 |
| 1 | 5 | 65 | | 20 | | | | | 10 | | | |
| 2 | 2.4 | 75 | 5 | 4 | | 5 | | | | 6 | | 5 |
| 2 | 4.1 | 80 | 3 | 5 | 2 | 10 | | 0.3 | | | | |
| 1 | 3.2 | 65 | | 5 | 4 | 6 | | | 5 | 4 | 6 | 5 |
| 1 | 5.1 | 96 | | | | | | | | 4 | | |
| 1 | 10.8 | 90 | 5 | | | | | | 5 | | | |
| 2 | 10.0 | 80 | 2 | 6 | 2 | 5 | | | 1 | | 4 | |
| 2 | 1.8 | 80 | | 5 | | | | | | | 15 | |
| 1 | 2.6 | 84 | | | 11 | | | | | | 5 | |
| 2 | 3.3 | 80 | 2 | | | 10 | | | | 2 | | 6 |
| 2 | 12.0 | 90 | | | | 7 | 0.3 | | 3 | | | |
| 1 | 5.4 | 69 | 2 | 20 | 2 | 1 | | | | | 3 | 3 |
| 2 | 6.0 | 91 | | | 4 | | | | | | 5 | |

TABLE II

| | Dye | | | | | | | | | | | |
|---|---|---|---|---|---|---|---|---|---|---|---|---|
| Dye | Content | Water | PG | DEG | NMP | CET | TBT | TDG | BDL | PHO | 2P | PI2 |
| 1 | 3.0 | 80 | 15 | | | 0.2 | | | | | 5 | |
| 1 | 9.0 | 90 | | 5 | | | | | | 1.2 | | 5 |
| 2 | 1.5 | 85 | 5 | 5 | | 0.15 | 5.0 | 0.2 | | | | |
| 2 | 2.5 | 90 | | 6 | 4 | | | | | 0.12 | | |
| 1 | 3.1 | 82 | 4 | 8 | | 0.3 | | | | | | 6 |
| 1 | 0.9 | 85 | | 10 | | | | | 5 | 0.2 | | |
| 2 | 8.0 | 90 | | 5 | 5 | | | 0.3 | | | | |
| 2 | 4.0 | 70 | | 10 | 4 | | | | 1 | | 4 | 11 |
| 1 | 2.2 | 75 | 4 | 10 | 3 | | | | 2 | | 6 | |
| 2 | 10.0 | 91 | | | 6 | | | | | | 3 | |
| 1 | 9.0 | 76 | | 9 | 7 | | 3.0 | | | 0.95 | 5 | |
| 2 | 5.0 | 78 | 5 | 11 | | | | | | | 6 | |
| 1 | 5.4 | 86 | | | 7 | | | | | | 7 | |
| 1 | 2.1 | 70 | 5 | 5 | 5 | 0.1 | 0.2 | 0.1 | 5 | 0.1 | 5 | |
| 2 | 2.0 | 90 | | 10 | | | | | | | | |
| 2 | 2 | 88 | | | | | | 10 | | | | |
| 1 | 5 | 78 | | | 5 | | | 12 | | | 5 | |
| 1 | 8 | 70 | 2 | | 8 | | | 15 | | | 5 | |
| 2 | 10 | 80 | | | | | | 8 | | | 12 | |
| 1 | 10 | 80 | | 10 | | | | | | | | |

1. A composition comprising a dye of Formula (1) or salt thereof and a dye of Formula (2) or salt thereof: 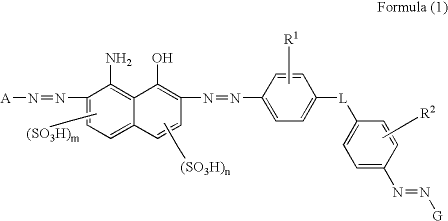
wherein:
A and G are optionally substituted aryl groups;
m is 0 or 1;
n is 0 or 1;
(m+n) is 1 or 2;
R¹ and R² are each independently H, optionally substituted alkyl, optionally substituted alkoxy, SO₃H or CO₂H;
L is NH, SO₂NH or CONH; and 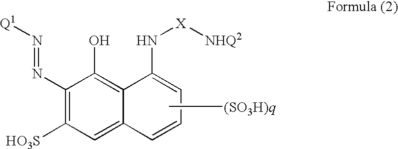
wherein:
Q¹ and Q² are each independently optionally substituted aryl groups;
X is an optionally substituted triazine or pyrimidine group; and
q is 0 or 1.

2. A composition according to claim 1 wherein the black dye of Formula (1) is of the Formula (1a) shown below or a salt thereof:

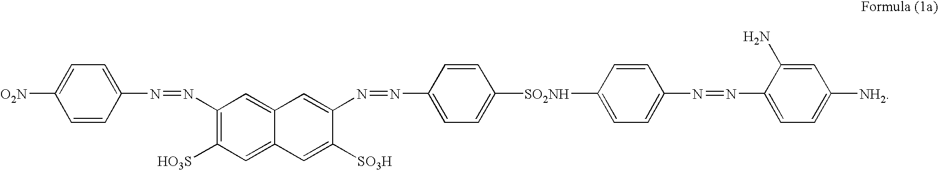

3. A composition according to claim 1 wherein the dye of Formula (2) is of the Formula (2a) shown below or a salt thereof:

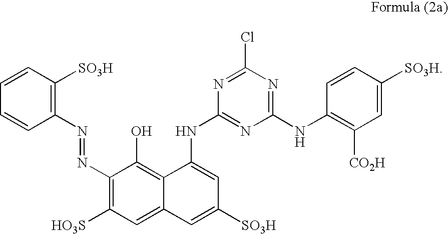

4. A composition according to claim 1 wherein the dye of Formula (2) is of the Formula (2b) shown below or a salt thereof:

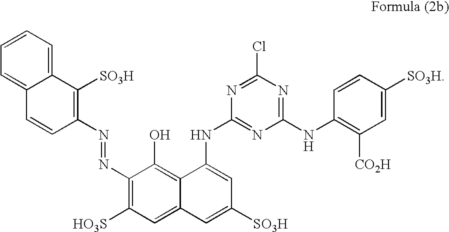

5. A composition according to claim 1 wherein the black dye of Formula (1) is of the Formula (1a) or a salt thereof and the dye of the Formula (2) is of the Formula (2a) or a salt thereof:

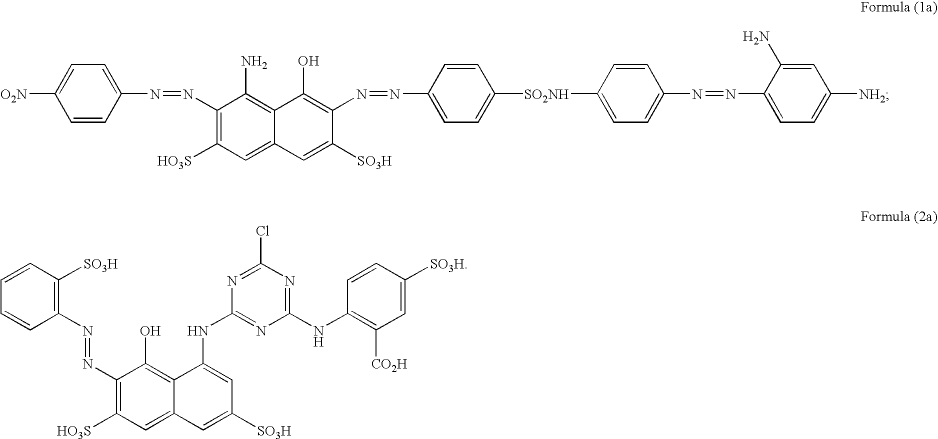

6. A composition according to claim 1 wherein the black dye of Formula (1) is of the Formula (1a) or a salt thereof and the dye of the Formula (2) is of the Formula (2b) or a salt thereof:

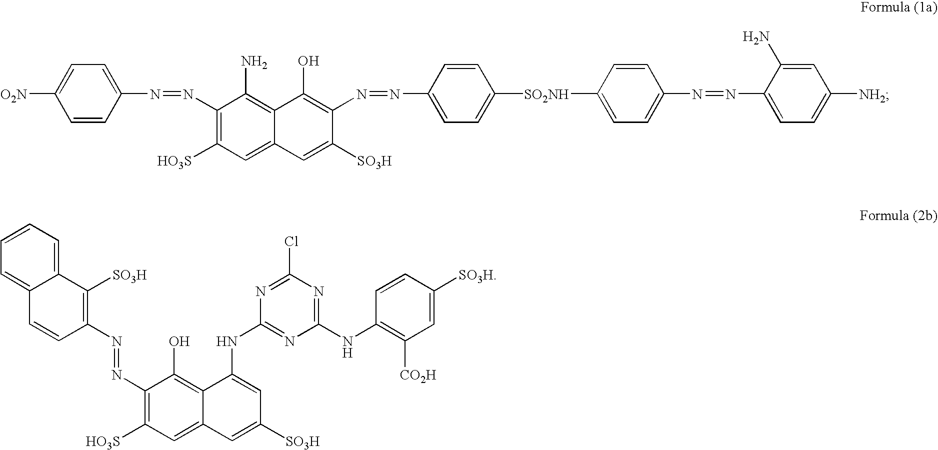

7. A composition according to claim 1 comprising from 3 to 10 parts in total of dye(s) of Formula (1) per 1 part in total of dye(s) of Formula (2), wherein all parts are by weight.

8. A composition according to claim 5 comprising from 3 to 10 parts in total of the dye of Formula (1a) per 1 part in total of the dye of Formula (2a), wherein all parts are by weight.

9. A composition according to claim 6 comprising from 3 to 10 parts in total of the dye of Formula (1a) per 1 part in total of the dye of Formula (2b), wherein all parts are by weight.

10. An ink comprising a liquid medium, a dye of Formula (1) or salt thereof and a dye of Formula (2) or salt thereof: 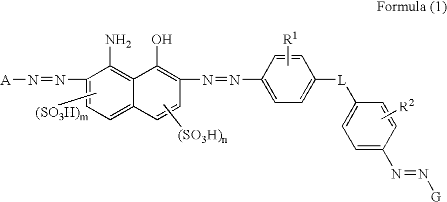
wherein:
A and G are optionally substituted aryl groups;
m is 0 or 1;
n is 0 or 1;
(m+n) is 1 or 2;
R¹ and R² are each independently H, optionally substituted alkyl, optionally substituted alkoxy, SO₃H or CO₂H;
L is NH, SO₂NH or CONH; and 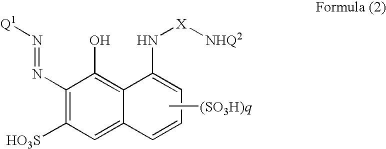
wherein:
Q¹ and Q² are each independently optionally substituted aryl groups;
X is an optionally substituted triazine or pyrimidine group; and
q is 0 or 1.

11. An ink according to claim 10 comprising from 3 to 10 parts in total of dye(s) of Formula (1) per 1 part in total of dye(s) of Formula (2), wherein all parts are by weight.

12. An ink according to claim 10 wherein the black dye of Formula (1) is of the Formula (1a) or a salt thereof and the dye of the Formula (2) is of the Formula (2a) or a salt thereof:

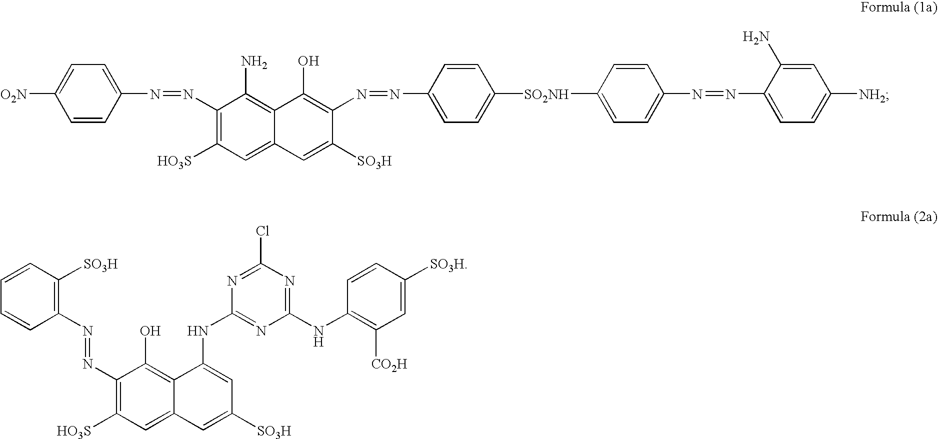

13. An ink according to claim 10 comprising a composition wherein the black dye of Formula (1) is of the Formula (1a) or a salt thereof and the dye of the Formula (2) is of the Formula (2b) or a salt thereof:

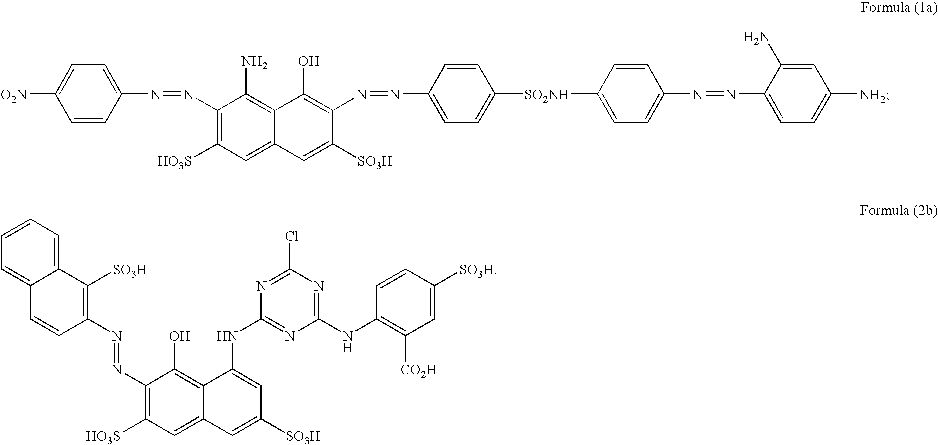

14. An ink according to claim 10 which has a total concentration of undesirable ions of less than 10 parts per million by weight relative to the weight of ink.

15. An ink according to claim 11 which has a total concentration of undesirable ions of less than 10 parts per million by weight relative to the weight of ink.

16. A process for printing a substrate with an ink using an ink jet printer, characterised in that the ink comprises a liquid medium, a dye of Formula (1) or salt thereof and a dye of Formula (2) or salt thereof: 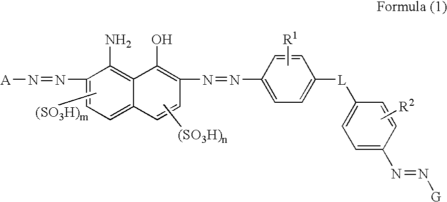
wherein:
A and G are optionally substituted aryl groups;
m is 0 or 1;
n is 0 or 1;
(m+n) is 1 or 2;
R¹ and R² are each independently H, optionally substituted alkyl, optionally substituted alkoxy, SO₃H or CO₂H;
L is NH, SO₂NH or CONH; and 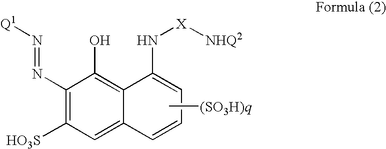
wherein:
Q¹ and Q² are each independently optionally substituted aryl groups;
X is an optionally substituted triazine or pyrimidine group; and
q is 0 or 1.

17. A process according to claim 16 wherein the black dye of Formula (1) is of the Formula (1a) or a salt thereof and the dye of the Formula (2) is of the Formula (2a) or a salt thereof:

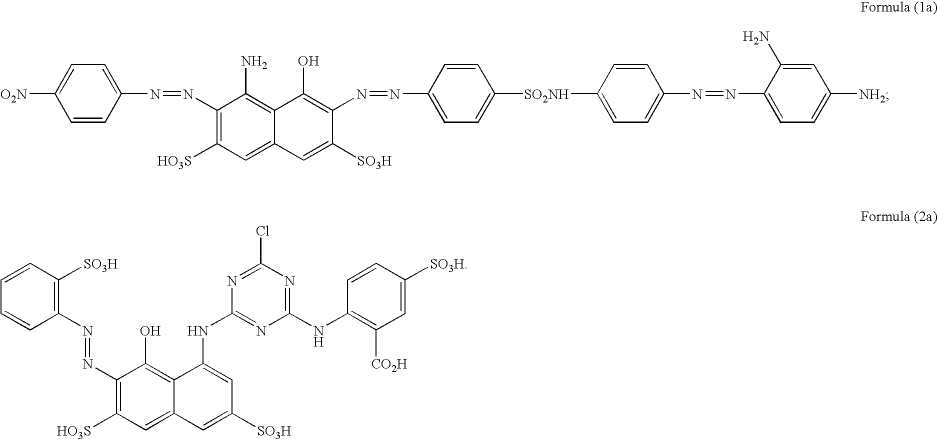

18. A process according to claim 16 wherein the black dye of Formula (1) is of the Formula (1a) or a salt thereof and the dye of the Formula (2) is of the Formula (2b) or a salt thereof:

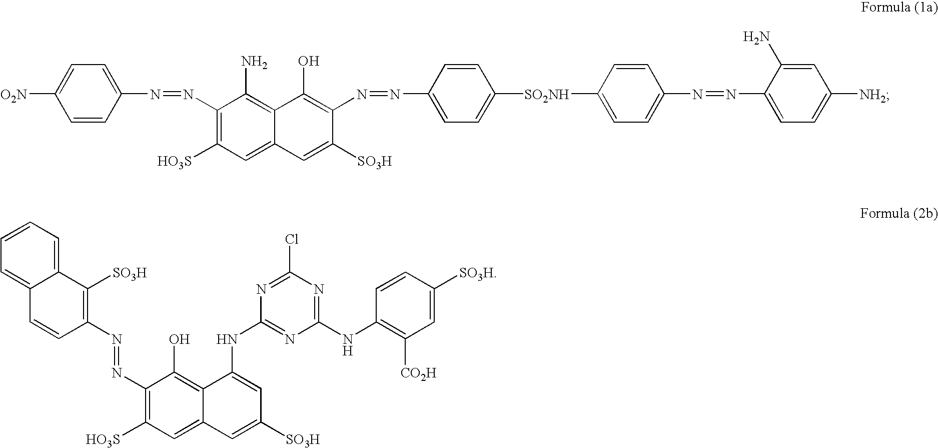

19. An ink jet printer cartridge, optionally refillable, comprising a chamber and an ink wherein the ink is present in the chamber and the ink comprises a liquid medium, a dye of Formula (1) or salt thereof and a dye of Formula (2) or salt thereof: 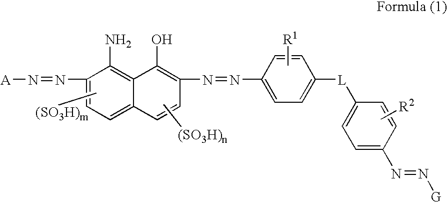
wherein:
A and G are optionally substituted aryl groups;
m is 0 or 1;
n is 0 or 1;
(m+n) is 1 or 2;
R¹ and R² are each independently H, optionally substituted alkyl, optionally substituted alkoxy, SO₃H or CO₂H;
L is NH, SO₂NH or CONH; and 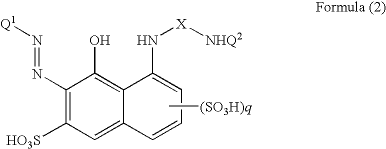
wherein:
Q¹ and Q² are each independently optionally substituted aryl groups;
X is an optionally substituted triazine or pyrimidine group; and
q is 0 or 1.

20. An ink jet printer cartridge according to claim 19 wherein the black dye of Formula (1) is of the Formula (1a) or a salt thereof and the dye of the Formula (2) is of the Formula (2a) or a salt thereof:

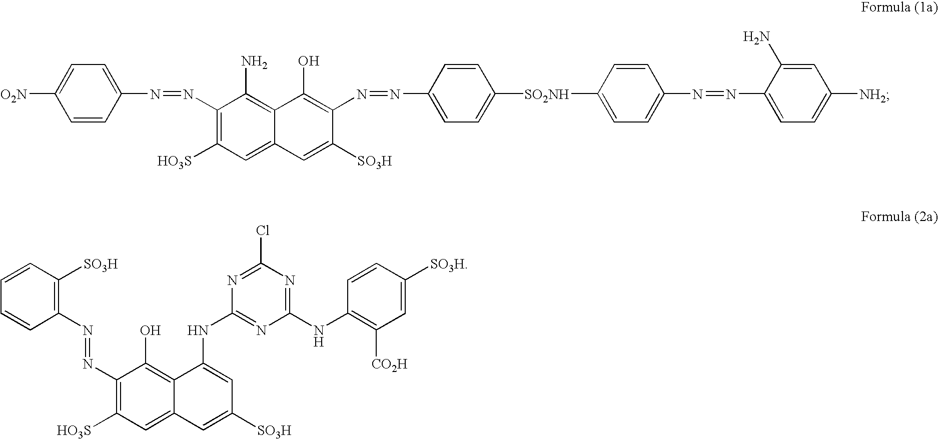

21. An ink jet printer cartridge according to claim 19 wherein the ink has a total concentration of undesirable ions of less than 10 parts per million by weight relative to the weight of ink.

22. An ink jet printer cartridge according to claim 20 wherein the ink has a total concentration of undesirable ions of less than 10 parts per million by weight relative to the weight of ink.
